(19) United States
(12) Patent Application Publication
(10) Pub. No.: US 2017/0306904 A1
(43) Pub. Date: Oct. 26, 2017

(54) INTAKE NOISE REDUCTION DEVICE

(71) Applicant: NOK CORPORATION, Tokyo (JP)

(72) Inventors: Masahiko INOUE, Fujisawa-shi, Kanagawa (JP); Takuya SUGITANI, Kawasaki-shi, Kanagawa (JP); Yohei MIKI, Aso-shi, Kumamoto (JP)

(21) Appl. No.: 15/516,904

(22) PCT Filed: Oct. 2, 2015
(86) PCT No.: PCT/JP2015/078073

§ 371 Date: Apr. 5, 2017

(30) Foreign Application Priority Data
Oct. 7, 2014 (JP) 2014-206400

(51) Int. Cl. F02M 35/12

(52) U.S. Cl. CPC F02M 35/1211

(57) ABSTRACT

The intake noise reduction device is capable of suppressing hindrance to the airflow caused by deformation of a flow-regulating net portion and suppressing a reduction in the airflow amount. A linear portion having a mesh shape constituting a flow-regulating net portion 120 includes a circumferential linear portion 122 that extends circumferentially and, an radial width t1 in the upstream side, with respect to the airflow direction, of the circumferential linear portion 122 is larger than a radial width t2 in the downstream side thereof, and a radially outer surface 122A is constituted by a tapered surface that tapers toward the downstream side.

### CROSS-REFERENCE TO RELATED APPLICATIONS

This application is a National Stage of International Application No. PCT/JP2015/078073, filed Oct. 2, 2015, which claims priority to Japanese Application No. 2014-206400, filed Oct. 7, 2014. The entire disclosures of each of the above applications are incorporated herein by reference.

### FIELD

The present disclosure relates to an intake noise reduction device that is disposed in an intake pipe and reduces an intake noise.

### BACKGROUND

An intake pipe is provided internally with a throttle valve for controlling an intake amount. A problem arises in that an unusual noise occurs when the throttle valve is opened abruptly. In order to suppress the occurrence of such an unusual noise, there is a known technique for regulating the airflow by providing a flow-regulating net constituted by a linear portion having a mesh shape on the downstream side of the throttle valve. There is also a known technique for providing this flow-regulating net in an annular gasket that seals a gap between an end surface of one of two pipes constituting the intake pipe and an end surface of the other pipe thereof. In these techniques, the flow-regulating net is generally constituted by a material having high rigidity such as metal, and the gasket is constituted by an elastic body such as rubber. However, such a constitution involves significant costs, and in this respect, there is also a known intake noise reduction device in which the flow-regulating net is also constituted by an elastic body, and a flow-regulating net portion and a gasket portion are provided in integrated fashion (see PTL 1).

In the case where the flow-regulating net portion is constituted by an elastic body, however, the flow-regulating net portion may be damaged by being significantly deformed due to the airflow. In order to suppress such damage, it is conceivable to increase the diameter of the linear portion that constitutes the flow-guiding net portion. However, a projection of an area of the linear portion onto the direction of the airflow increases by simply increasing the diameter of the linear portion, and hence a mesh size is reduced and the airflow is hindered. When the airflow is hindered, the required amount of air to an engine is not secured due to a reduction in flow amount, which may cause deterioration in fuel efficiency. In this respect, in order to suppress the deformation while securing the airflow amount, it is conceivable to increase the depth of the linear portion (a length in the direction of the airflow; the same definition applies to the following description) while narrowing the width of the linear portion (a width when the linear portion is viewed in the direction of the airflow; the same definition applies to the following description). It has been found as a result of verification, however, that even when such a shape is adopted, it is difficult to adequately suppress the reduction in flow amount. This point will be described with reference to FIGS. 9 to 11.

FIG. 9 is a view of a case where an intake noise reduction device of a technique for reference is viewed in the direction of the airflow (hereinafter this type of drawing is referred to as a front view). FIG. 10 is a schematic cross-sectional view of the intake noise reduction device of the technique for reference, and is a cross-sectional view taken along a plane indicated by C-C in FIG. 9. FIG. 11 is a schematic cross-sectional view showing a state when the intake noise reduction device according to the technique for reference is used, and shows a state in which the throttle valve is fully opened and the flow amount is increased. FIG. 11 is the cross-sectional view taken along the plane indicated by C-C in FIG. 9 and, for the sake of explanation, only a cut surface (end surface) and a linear portion 521 in the vicinity of the cut surface are shown.

An intake noise reduction device 500 according to the technique for reference is constituted by an annular gasket portion 510 and a flow-regulating net portion 520 that is provided inside (radially inside) the gasket portion 510 integrally with the gasket portion 510. The intake noise reduction device 500 is constituted by the elastic body such as various rubber materials or a resin elastomer. The flow-regulating net portion 520 is constituted by a plurality of radial linear portions 521 that radially extend outwardly from the center of a circle of the gasket portion 510, and a plurality of circumferential linear portions 522 that are provided so as to circumferentially extend concentrically with respect to the center of the circle. Each of the linear portions 521 and 522 is configured such that its depth is longer than its width. In particular, as shown in FIG. 10, the circumferential linear portion 522 has a rectangular cross section.

In the thus configured intake noise reduction device 500, when a throttle valve 400 is open and air is flowing, the flow-regulating net portion 520 deforms such that its part in the vicinity of the circle center of the gasket portion 510 protrudes downstream in the direction of the airflow. When the flow-regulating net portion 520 deforms in this manner, the circumferential linear portion 522 deforms rotating in a direction indicated by an arrow R in FIG. 11 around a central axis along the extending direction of the circumferential linear portion 522. That is, torsional deformation occurs. Accordingly, a surface of the circumferential linear portion 522 that faces toward a depth direction is tilted, and hence the projection of the area of the circumferential linear portion 522 onto the direction of the airflow increases and the airflow is thereby hindered. As can be seen from FIG. 11, the increase in the projected area of the circumferential linear portion 522 is caused particularly by rotation of a radially outer surface 522A of the circumferential linear portion 522 in the direction of the arrow R against the airflow. To sum up, the circumferentially extending linear portion may hinder the airflow because of the deformation of the flow-regulating net portion during use, even in the case where the depth of the linear portion is made longer than the width thereof, and hence an effect of suppressing the reduction in the airflow amount is limited.

### CITATION LIST

### Patent Literature

[PTL 1] Japanese Patent Application Laid-open No. 2008-14279

### SUMMARY

### Technical Problem

An object of the present disclosure is to provide an intake noise reduction device capable of suppressing hindrance to the airflow caused by deformation of the flow-regulating net portion to thereby suppress reduction in the airflow amount.

### Solution to Problem

The present disclosure has adopted the following configuration in order to solve the above-described problem. That is, the intake noise reduction device of the present disclosure is an intake noise reduction device made of an elastic body that is disposed downstream of a throttle valve in an intake pipe and reduces an intake noise, the intake noise reduction device including an annular gasket portion that seals a gap between an end surface of one of two pipes constituting the intake pipe and an end surface of the other pipe of the two pipes, and a flow-regulating net portion that is provided inside the gasket portion integrally with the gasket portion, constituted by a linear portion having a mesh shape, and configured to reduce the intake noise by regulating an airflow, wherein the linear portion having the mesh shape constituting the flow-regulating net portion includes a circumferential linear portion that extends circumferentially, and a radial width of the circumferential linear portion is larger in the upstream side than in the downstream side with respect to the airflow direction and a radially outer surface of the circumferential linear portion has a tapered surface that tapers toward the downstream side with respect to the airflow direction.

According to the intake noise reduction device, even when the circumferential linear portion rotates by the deformation of the flow-regulating net portion, the tapered surface does not cause the projected area of the circumferential linear portion onto the direction of the airflow to increase unless the radially outer tapered surface appears as viewed in the direction of the airflow (in the following description, “projected area” means an area projected onto the direction of the airflow). That is, by providing the tapered surface, the increase in the projected area of the circumferential linear portion caused by the deformation of the flow-regulating net portion is suppressed. Therefore, according to the intake noise reduction device, the hindrance to the airflow caused by the deformation of the flow-regulating net portion is suppressed, and hence it becomes possible to suppress the reduction in the airflow amount.

The tapered surface may be configured to be substantially parallel to a direction of the airflow in a deformation state of the flow-regulating net portion where a flow amount of air passing through the flow-regulating net portion exceeds a predetermined amount.

Accordingly, it becomes possible to effectively suppress the hindrance to the airflow unless the flow amount of air passing through the flow-regulating net portion exceeds the predetermined amount. The predetermined amount can be set, for example, to the airflow amount when the throttle valve is fully opened.

The linear portion having the mesh shape may further include a radial linear portion that is provided integrally with the circumferential linear portion and extends radially, the radial linear portion may have an end surface in the upstream side that is perpendicular to the airflow in a state where the flow-regulating net portion does not deform, and the flow-regulating net portion may be configured to satisfy θ1≧θ2, where θ1 is an angle between (a) the end surface in the upstream side of the radial linear portion when the flow-regulating net portion is in the deformation state and (b) a plane perpendicular to the airflow, and θ2 is a taper angle of the tapered surface of the circumferential linear portion.

According to the configuration, when the angle θ1 becomes equal to the angle θ2 by the deformation of the flow-regulating net portion, the tapered surface of the circumferential linear portion becomes parallel to the airflow. When the angle θ1 becomes larger than the angle θ2 by the deformation of the flow-regulating net portion, the airflow directly impinges on the tapered surface, and hence a force that parallels the tapered surface again acts on the tapered surface. Therefore, by adopting this configuration, it becomes possible to stably maintain the tapered surface substantially parallel to the airflow, and hence it is possible to effectively suppress the hindrance to the airflow.

The intake noise reduction device of the present disclosure may also be configured in the following manner. That is, the intake noise reduction device of the present disclosure is an intake noise reduction device made of an elastic body that is disposed downstream of a throttle valve in an intake pipe and reduces an intake noise, the intake noise reduction device including an annular gasket portion that seals a gap between an end surface of one of two pipes constituting the intake pipe and an end surface of the other pipe of the two pipes, and a flow-regulating net portion that is provided inside the gasket portion integrally with the gasket portion, constituted by a linear portion having a mesh shape, and configured to reduce the intake noise by regulating an airflow, wherein the linear portion having the mesh shape constituting the flow-regulating net portion includes a circumferential linear portion that extends circumferentially, and a radial width of the circumferential linear portion is smaller in the upstream side than in the downstream side with respect to the airflow direction and a radially inner surface of the circumferential linear portion has a reverse tapered surface that tapers toward the upstream side with respect to the airflow direction.

According to the intake noise reduction device, when the circumferential linear portion rotates by the deformation of the flow-regulating net portion, the projected area of the reverse tapered surface decreases as the circumferential linear portion rotates. Therefore, the increase in the projected area of the circumferential linear portion is suppressed, and hence it becomes possible to suppress the reduction in the airflow amount.

The reverse tapered surface may be configured to be substantially parallel to a direction of the airflow in a deformation state of the flow-regulating net portion where a flow amount of air passing through the flow-regulating net portion exceeds a predetermined amount.

Accordingly, it becomes possible to effectively suppress the reduction in the airflow amount when the flow amount of air passing through the flow-regulating net portion exceeds the predetermined amount.

### Advantageous Effects of the Disclosure

Thus, according to the intake noise reduction device of the present disclosure, it is possible to suppress the hindrance to the airflow caused by the deformation of the flow-regulating net portion, and hence it becomes possible to suppress the reduction in the airflow amount.

### DRAWINGS

FIG. 1 is a front view of an intake noise reduction device according to Embodiment 1.

FIG. 2 is a schematic cross-sectional view of the intake noise reduction device according to Embodiment 1.

FIG. 3 is a schematic cross-sectional view showing a state when the intake noise reduction device according to Embodiment 1 is used.

FIG. 4 is a cross-sectional view for explaining a deformation state of a flow-regulating net portion according to Embodiment 1.

FIG. 5 is a schematic cross-sectional view of an intake noise reduction device according to Embodiment 2.

FIG. 6 is a schematic cross-sectional view showing a state when the intake noise reduction device according to Embodiment 2 is used.

FIG. 7 is a schematic cross-sectional view of an intake noise reduction device according to Modification 1.

FIG. 8 is a schematic cross-sectional view of an intake noise reduction device according to Modification 2.

FIG. 9 is a front view of an intake noise reduction device according to a technique for reference.

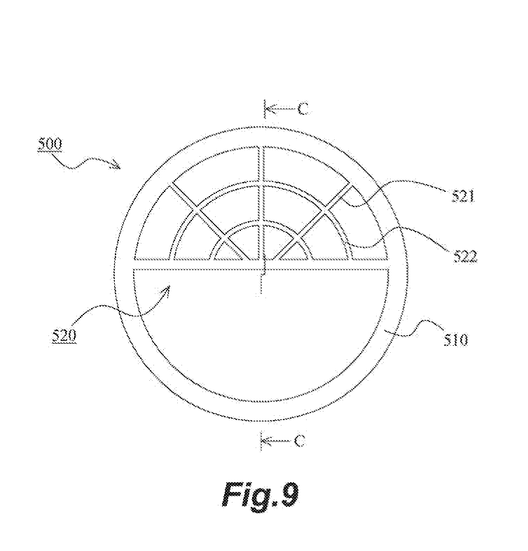

FIG. 10 is a schematic cross-sectional view of the intake noise reduction device according to the technique for reference.

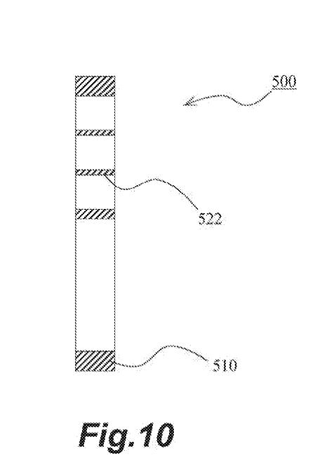

FIG. 11 is a schematic cross-sectional view showing a state when the intake noise reduction device according to the technique for reference is used.

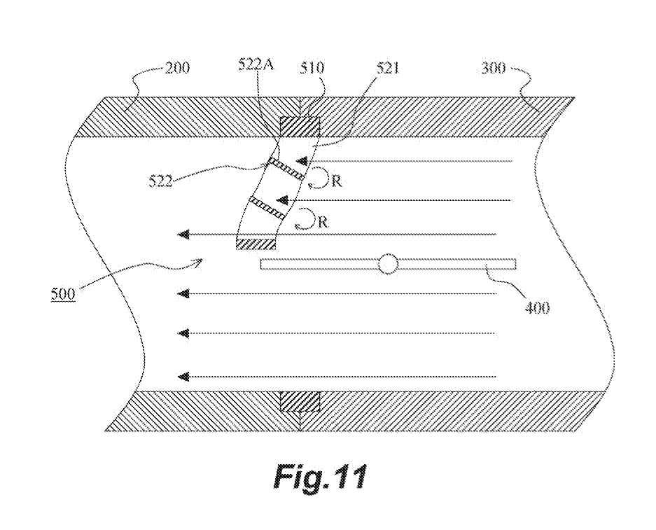

### DETAILED DESCRIPTION

Hereinbelow, with reference to the drawings, a mode for carrying out the disclosure will be illustratively described in detail based on embodiments. It should be noted that, however, unless otherwise specified expressly, the dimensions, materials, shapes, and relative arrangements of the components described in these embodiments are not intended to limit the scope of the present disclosure to these dimensions, materials, shapes, and relative arrangements.

### Embodiment 1

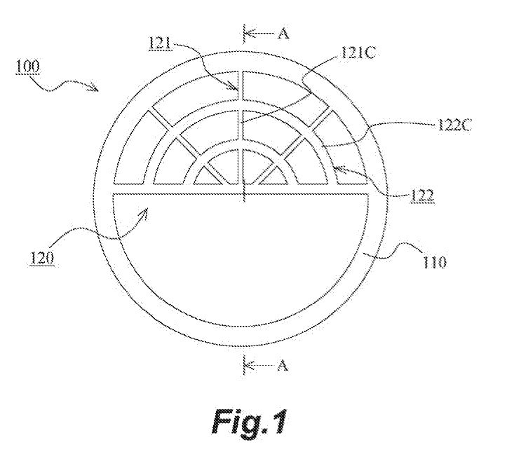

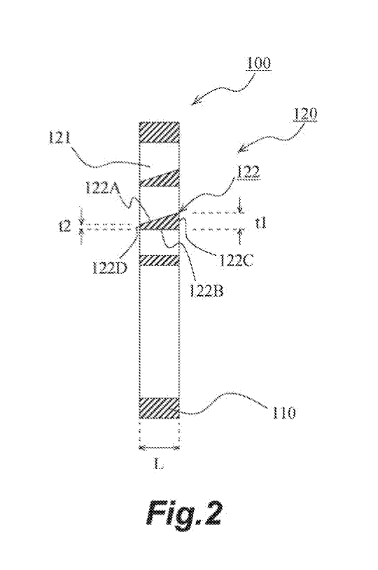

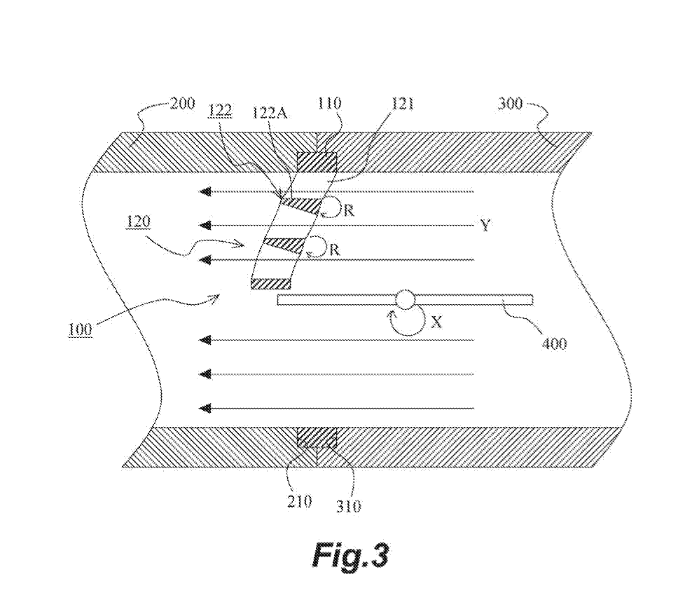

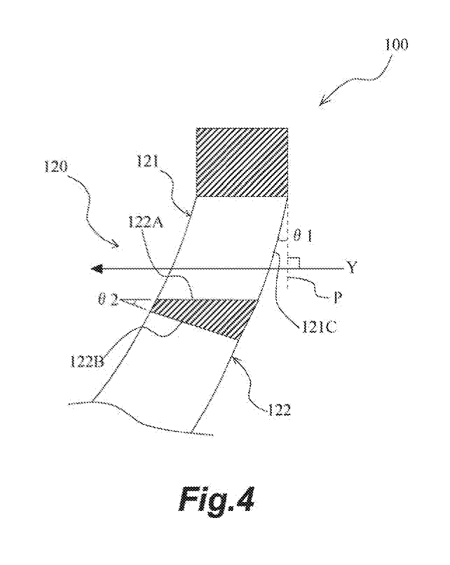

With reference FIGS. 1 to 4, an intake noise reduction device according to Embodiment 1 of the present disclosure will be described. FIG. 1 is a front view of the intake noise reduction device according to Embodiment 1 of the present disclosure as viewed in a direction of the airflow. FIG. 2 is a schematic cross-sectional view of the intake noise reduction device according to Embodiment 1, and is a cross-section view taken along a plane indicated by A-A in FIG. 1. FIG. 3 is a schematic cross-sectional view showing a state when the intake noise reduction device according to Embodiment 1 of the present disclosure is used, and shows a state when a throttle valve is fully opened and the airflow amount is increased. FIG. 4 is a cross-sectional view (enlarged cross-sectional view) for explaining a deformation state of a flow-regulating net portion according to Embodiment 1 shown in FIG. 3. The cross-sectional view of the intake noise reduction device in each of FIGS. 3 and 4 is the cross-sectional view taken along the plane indicated by A-A in FIG. 1 and, for the sake of explanation, only a cut surface (end surface) and a radial linear portion 121 in the vicinity of the cut surface are shown.

An intake noise reduction device 100 according to the present embodiment is constituted by an elastic body such as various rubber materials or a resin elastomer. The intake noise reduction device 100 is constituted by an annular gasket portion 110 and a flow-regulating net portion 120. The flow-regulating net portion 120 is provided inside (radially inside) the gasket portion 110 integrally with the gasket portion 110. The intake noise reduction device 100 in which the gasket portion 110 and the flow-regulating net portion 120 are integrally provided can be formed by molding. Techniques related to molding are known, and hence the description thereof will be omitted.

The gasket portion 110 seals a gap between an end surface of one of two pipes that constitute an intake pipe and an end surface of the other pipe of the two pipes. The flow-regulating net portion 120 is constituted by a linear portion having a mesh shape, and configured to reduce an intake noise by regulating the airflow.

The intake noise reduction device 100 according to the present embodiment is disposed downstream (downstream in a direction of the airflow when air is taken in) of a throttle valve 400 in the intake pipe. In the present embodiment, the intake noise reduction device 100 is disposed in the vicinity of a connection part between an intake manifold 200 (one pipe) and a throttle body 300 (the other pipe) that constitute the intake pipe. In the present embodiment, the rotation axis of the throttle valve 400 is installed horizontally. The throttle valve 400 is configured such that the valve is opened by rotating in a direction indicated by an arrow X in FIG. 3. With the configuration described above, the airflow in the intake pipe is basically not influenced by the throttle valve 400 when the throttle valve 400 is fully opened, and hence air flows in a direction indicated by an arrow Y in FIG. 3. The direction indicated by the arrow Y corresponds to the direction of the airflow in the present disclosure. The front view of the intake noise reduction device 100 shown in FIG. 1 shows the intake noise reduction device 100 as viewed in the direction of the arrow Y. In the following description, an upstream side and a downstream side are defined based on the airflow.

In the present embodiment, the intake pipe has a cylindrical shape. Thus, the gasket portion 110 has an annular shape. The gasket portion 110 is disposed so as to be fitted in an annular groove formed of an annular notch 210 that is formed along the inner periphery of the end surface of the intake manifold 200 and an annular notch 310 that is formed along the inner periphery of the end surface of the throttle body 300. The gasket portion 110 is held between the end surface of the intake manifold 200 and the end surface of the throttle body 300 so that it seals the gap between these end surfaces.

The flow-regulating net portion 120 is disposed inside the gasket portion 110 having a circular planar shape. The flow-regulating net portion 120 is constituted by a plurality of radial linear portions 121 that radially outwardly extend from the center of the circle of the gasket portion 110 in a radial manner, and a plurality of circumferential linear portions 122 that circumferentially extend concentrically with respect to the center of the above-described circle. In the present embodiment, five radial linear portions 121 and two circumferential linear portions 122 are provided. A Mesh shape is formed of the plurality of radial linear portions 121 and the plurality of circumferential linear portions 122. In the present embodiment, angles between adjacent radial linear portions 121 are set to be substantially equal to each other. Radial intervals between adjacent circumferential linear portions 122 are set to be substantially equal to each other. Accordingly, the mesh size of the flow-regulating net portion 120 is small in the vicinity of the center of the circle of the gasket portion 110 and is increased with distance from the center.

In the present embodiment, as shown in FIG. 3, an interval between the throttle valve 400 and the flow-regulating net portion 120 is shorter than half of the length of a valve main body part of the throttle valve 400. The flow-regulating net portion 120 is configured to occupy almost half of an area inside the gasket portion 110 which has the circular planar shape such that the throttle valve 400 does not come into contact with the flow-regulating net portion 120. The remaining substantially semicircular part of the flow-regulating net portion 120 is configured to form hollow. In a state in which the intake noise reduction device 100 is disposed in the intake pipe, the semicircular area where the flow-regulating net portion 120 is provided is positioned in an upper part, and the hollow semicircular area is positioned in a lower part. Accordingly, even when the throttle valve 400 is fully opened, the throttle valve 400 does not come into contact with the flow-regulating net portion 120 (see FIG. 3).

### Detail of Linear Portion

The radial linear portion 121 and the circumferential linear portion 122 that constitute the flow-regulating net portion 120 will be described in greater detail based particularly on FIGS. 1 and 2. Each of the drawings shows a state when the intake noise reduction device 100 is not deformed. In FIG. 2, the right side in the drawing corresponds to the upstream side. The circumferential linear portion 122 constituting the flow-regulating net portion 120 according to the present embodiment is configured such that a radial width t1 in the upstream side is larger than a radial width t2 in the downstream side. The radial width is a width of the circumferential linear portion 122 as viewed in the direction of the airflow (a width of the intake noise reduction device as viewed from the front as shown in FIG. 1), and may be said a thickness of the circumferential linear portion 122. In the circumferential linear portion 122, a surface 122A, which is a radially outer surface, is constituted by a surface tapering toward the downstream side (a surface that is tapered toward the downstream side). The surface 122A is a linear tapered surface having a taper angle θ2 (see FIG. 4). A surface 122B, which is a radially inner surface of the circumferential linear portion 122, is constituted by a cylindrical inner peripheral surface parallel to the airflow in a state where the flow-regulating net portion 120 does not deform. Each of an end surface 122C in the upstream side and an end surface 122D in the downstream side of the circumferential linear portion 122 is constituted by an annular surface that is perpendicular to the airflow in the state where the flow-regulating net portion 120 does not deform. The circumferential linear portion 122 is quadrilateral in the cross section shown in FIG. 2 (the cross section by a plane perpendicular to the direction in which the circumferential linear portion 122 extends). In the circumferential linear portion 122, a length (depth) L in the direction of the airflow is set to be longer than the radial width t1 or t2.

The radial linear portion 121 that constitutes the flow-regulating net portion 120 and is provided integrally with the circumferential linear portion 122 includes an end surface 121C in the upstream side that is perpendicular to the airflow in the state where the flow-regulating net portion 120 does not deform. The radial linear portion 121 is formed such that a width (thickness) as viewed in the direction of the airflow is substantially constant. In the radial linear portion 121, a length (depth) L in the direction of the airflow is set to be longer than the thickness.

From the viewpoint of suppressing a reduction in the airflow amount, the thickness of each of the radial linear portion 121 and the circumferential linear portion 122 is preferably as small as possible. From the viewpoint of suppressing the deformation of the flow-regulating net portion 120, the depth of each of the radial linear portion 121 and the circumferential linear portion 122 is preferably as long as possible.

### Behavior of Flow-Regulating Net Portion

The state where the flow-regulating net portion 120 deforms due to the airflow will be described in detail. When the throttle valve 400 is opened or closed and the flow amount of air flowing in the intake pipe is changed, the flow-regulating net portion 120 deforms based on a direction or a flow amount of the airflow. When the throttle valve 400 is opened and the airflow amount is gradually increased, the radial linear portion 121 extends while bending toward the downstream side. When the throttle valve 400 is opened and the airflow amount is gradually increased, as indicated by an arrow R in FIG. 3, the circumferential linear portion 122 deforms rotating around a central axis along the extending direction of the circumferential linear portion 122. That is, torsional deformation occurs. Since the radially outer surface 122A of the circumferential linear portion 122 is constituted by the tapered surface that extends downstream, even when the circumferential linear portion 122 rotates, the surface 122A does not appear as viewed in the direction of the airflow unless the surface 122A becomes parallel to the direction of the airflow. That is, the surface 122A does not cause the projected area of the circumferential linear portion 122 to increase unless the surface 122A becomes parallel to the direction of the airflow. Consequently, even when the flow-regulating net portion 120 deforms, hindrance to the airflow is suppressed.

In the present embodiment, the surface 122A is configured so as to be substantially parallel to the direction of the airflow in the deformation state of the flow-regulating net portion 120 when the flow amount of air passing through the flow-regulating net portion 120 exceeds a predetermined amount (preset amount) (see FIG. 3). Consequently, the surface 122A does not cause the projected area of the circumferential linear portion 122 to increase until the flow amount of air passing through the flow-regulating net portion 120 exceeds the predetermined amount. In the present embodiment, the predetermined amount can be set to the airflow amount when the throttle valve 400 is fully opened.

In the present embodiment, as shown in FIG. 4, the flow-regulating net portion 120 is configured to satisfy θ1≧θ2, where θ1 is an angle between (a) the end surface 121C of the radial linear portion 121 when the flow-regulating net portion 120 is in the above-described deformation state (the deformation state when the flow amount of air passing through the flow-regulating net portion 120 exceeds the predetermined amount) and (b) a plane P perpendicular to the airflow, and θ2 is the taper angle of the surface 122A of the circumferential linear portion 122. When the angle θ1 becomes equal to the angle θ2 by the deformation of the flow-regulating net portion 120, the surface 122A of the circumferential linear portion 122 becomes parallel to the airflow. When the angle θ1 becomes larger than the angle θ2 by further deformation of the flow-regulating net portion 120, the airflow directly impinges on the surface 122A. That is, a force that parallels the surface 122A again acts on the surface 122A. Accordingly, the surface 122A is stably maintained substantially parallel to the airflow, and hence the hindrance to the airflow is effectively suppressed.

The above-described angle θ1 may also be an angle between (a) the end surface 122C of the circumferential linear portion 122 when the flow-regulating net portion 120 is in the above-described deformation state (the deformation state when the flow amount of air passing through the flow-regulating net portion 120 exceeds the predetermined amount) and (b) the plane perpendicular to the airflow.

It is known that, a member having a mesh shape disposed downstream of the throttle valve 400 can suppress the occurrence of an unusual noise resulting from a change in the flow of air flowing in the intake pipe, even when the width of the linear portion constituting the mesh is small. That is, in the present embodiment, the function of suppressing the occurrence of the unusual noise is achieved by both of the radial linear portion 121 and the circumferential linear portion 122.

### Advantages of the Intake Noise Reduction Device According to the Present Embodiment

According to the intake noise reduction device 100 according to the present embodiment, the radial width t1 in the upstream side of the circumferential linear portion 122 that constitutes the flow-regulating net portion 120 is larger than the radial width t2 in the upstream side thereof, and the radially outer surface 122A is constituted by the tapered surface that tapers toward the downstream side. Accordingly, even when the circumferential linear portion 122 rotates by the deformation of the flow-regulating net portion 120, the increase in the projected area of the circumferential linear portion 122 is suppressed until the surface 122A becomes parallel to the direction of the airflow. According to the intake noise reduction device 100, it is possible to suppress the hindrance to the airflow, and hence it becomes possible to suppress the reduction in the airflow amount. The surface 122A is configured to be substantially parallel to the direction of the airflow in the deformation state of the flow-regulating net portion 120 where the flow amount of air passing through the flow-regulating net portion 120 exceeds the predetermined amount. Accordingly, it becomes possible to suppress the hindrance to the airflow until the flow amount of air passing through the flow-regulating net portion 120 exceeds the predetermined amount.

In the present embodiment, the flow-regulating net portion 120 is configured so as to satisfy θ1≧θ2, where θ1 is the angle between the end surface 121C and the plane P perpendicular to the airflow in the deformation state of the flow-regulating net portion 120 when the flow amount of air passing through the flow-regulating net portion 120 exceeds the predetermined amount, and θ2 is the taper angle of the surface 122A. According to this configuration, when the flow-regulating net portion 120 deforms to the extent that the angle θ1 is larger than the angle θ2, the force that parallels the surface 122A again acts on the surface 122A by the airflow. Therefore, according to the present embodiment, it becomes possible to stably maintain the surface 122A substantially parallel to the airflow, and hence it is possible to effectively suppress the hindrance to the airflow.

### Embodiment 2

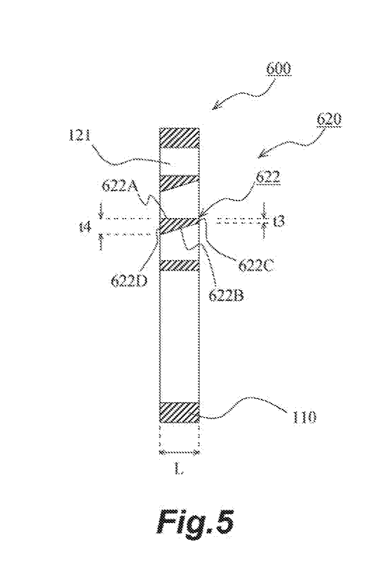

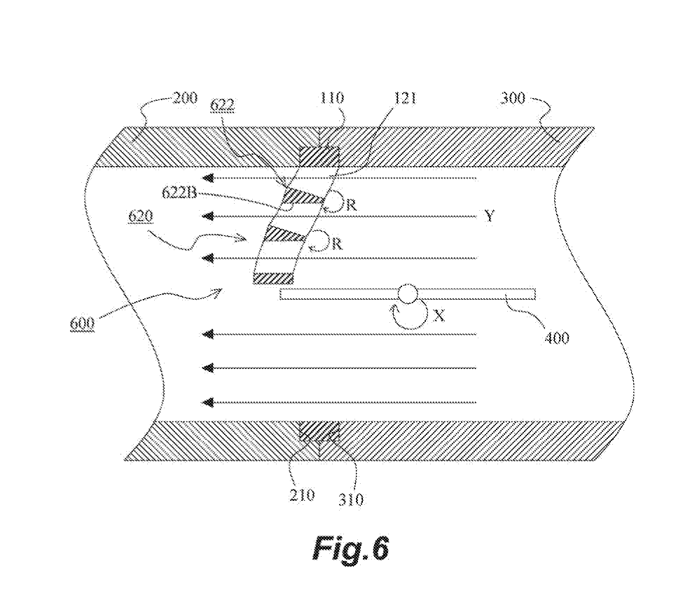

Each of FIGS. 5 and 6 shows Embodiment 2 of the present disclosure. In Embodiment 1 described above, the radial width in the upstream side of the circumferential linear portion is larger than the radial width in the downstream side thereof, and the radially outer surface is constituted by the tapered surface that tapers toward the downstream side. In Embodiment 2, the radial width in the upstream side of the circumferential linear portion is smaller than the radial width in the downstream side thereof, and the radially inner surface is constituted by a reverse tapered surface that tapers toward the upstream side. The other configurations are the same as those in Embodiment 1, and hence the same components as those in Embodiment 1 are designated by the same reference signs as those in Embodiment 1 and the description thereof will be omitted.

FIG. 5 is a schematic cross-sectional view, like FIG. 2 described above, of an intake noise reduction device according to Embodiment 2 of the present disclosure. FIG. 6 is a schematic cross-sectional view, like FIG. 3 described above, of the intake noise reduction device being used according to Embodiment 2 of the present disclosure. In an intake noise reduction device 600 according to the present embodiment, among the linear portions constituting a flow-regulating net portion 620, only the configuration of a circumferential linear portion 622 is different from the configuration of the intake noise reduction device 100 described in Embodiment 1. The other configurations are the same as those of the intake noise reduction device 100, and hence the description thereof will be omitted.

The circumferential linear portion 622 constituting the flow-regulating net portion 620 according to the present embodiment is configured such that a radial width t3 in the upstream side of the circumferential linear portion 622 is smaller than a radial width t4 in the downstream side thereof. A surface 622B, which is the radially inner surface of the circumferential linear portion 622, is constituted by a reverse tapered surface that tapers toward the upstream side (a surface having a bowl-like shape that radially expands toward the upstream side). A surface 622A, which is the radially outer surface of the circumferential linear portion 622, is constituted by a cylindrical surface parallel to the airflow in the state where the flow-regulating net portion 620 does not deform. Each of an end surface 622C in the upstream side and an end surface 622D in the downstream side of the circumferential linear portion 622 is constituted by an annular surface that is perpendicular to the airflow in the state where the flow-regulating net portion 620 does not deform. The circumferential linear portion 622 is quadrilateral in the cross section shown in FIG. 5 (the cross section by a plane perpendicular to the direction in which the circumferential linear portion 622 extends). In the circumferential linear portion 622, a length (depth) L in the direction of the airflow is set to be longer than the radial width (thickness) t3 or t4. As described in Embodiment 1, from the viewpoint of suppressing the reduction in the airflow amount, the thickness of the circumferential linear portion 622 is preferably as small as possible, and the depth thereof is preferably as long as possible.

### Behavior of Flow-Regulating Net Portion

The state where the flow-regulating net portion 620 deforms due to the airflow will be described in detail. When the throttle valve 400 is opened or closed and the flow amount of air flowing in the intake pipe is changed, the flow-regulating net portion 620 deforms based on a direction or a flow amount of the airflow. The radial linear portion 121 deforms similarly to the case of Embodiment 1 described above. When the closed throttle valve 400 is opened and the airflow amount is gradually increased, the circumferential linear portion 622 deforms rotating around a central axis along the extending direction of the linear portion as indicated by an arrow R in FIG. 6. That is, torsional deformation occurs. Since the radially inner surface 622B of the circumferential linear portion 622 is constituted by the reverse tapered surface that tapers toward the upstream side, the projected area of the circumferential linear portion 622 decreases as it rotates in the direction indicated by the arrow R. Accordingly, even when the projected areas of the other surfaces of the circumferential linear portion 622 increase due to the rotation, an increase in the projected area of the circumferential linear portion 622 is suppressed.

In the present embodiment, the surface 622B is configured to be substantially parallel to the direction of the airflow in the deformation state of the flow-regulating net portion 620 where the flow amount of air passing through the flow-regulating net portion 620 exceeds the predetermined amount (see FIG. 6). Accordingly, the projected area of the surface 622B is substantially zero when the flow amount of air passing through the flow-regulating net portion 620 exceeds the predetermined amount, and hence it becomes possible to effectively suppress the reduction in the airflow amount. The predetermined amount may be set similarly to Embodiment 1.

### Advantages of the Intake Noise Reduction Device According to the Present Embodiment

According to the intake noise reduction device 600 according to the present embodiment, in the circumferential linear portion 622 that constitutes the flow-regulating net portion 620, the radial width t3 in the upstream side of the circumferential linear portion 622 is smaller than the radial width t4 in the downstream side thereof, and the radially outer surface 622B is constituted by the reverse tapered surface that tapers toward the upstream side. When the circumferential linear portion 622 rotates by the deformation of the flow-regulating net portion 620, the projected area of the surface 622B decreases until the surface 622B becomes parallel to the direction of the airflow. According to the intake noise reduction device 600, it is possible to suppress the hindrance to the airflow, and hence it becomes possible to suppress the reduction in the airflow amount. The surface 622B is configured to be substantially parallel to the direction of the airflow in the deformation state of the flow-regulating net portion 620 where the flow amount of air passing through the flow-regulating net portion 620 exceeds the predetermined amount. Accordingly, when the flow amount of air passing through the flow-regulating net portion 620 exceeds the predetermined amount, it becomes possible to effectively suppress the reduction in the flow amount of the airflow.

### Modification

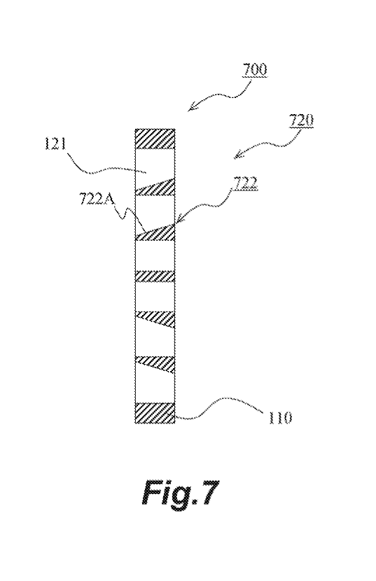

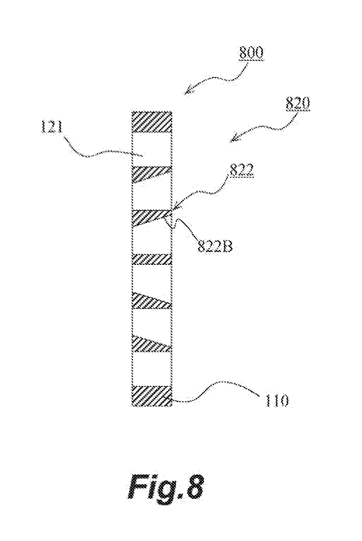

Each of FIGS. 7 and 8 shows a modification of the present disclosure. Each embodiment described above shows the configuration where the flow-regulating net portion is provided in the substantially semicircular area inside the gasket portion. In contrast to this, the modification describes a configuration where the flow-regulating net portion is provided over the entire area inside the gasket portion. The other configurations and behavior are the same as those in the above-described embodiments, and hence the same components as those in the above-described embodiments are designated by the same reference signs as those in the embodiments and the description thereof will be omitted.

FIG. 7 is a schematic cross-sectional view of an intake noise reduction device according to Modification 1 of the present disclosure, and is a cross-sectional view similar to FIG. 2 described above. An intake noise reduction device 700 according to the present modification is constituted, similarly to Embodiment 1 described above, by the annular gasket portion 110 and a flow-regulating net portion 720. The flow-regulating net portion 720 is constituted, similarly to Embodiment 1 described above, by a plurality of the radial linear portions 121 that radially extend outwardly from the center of the circle of the gasket portion 110 in the radial manner, and a plurality of circumferential linear portions 722 that circumferentially extend concentrically with respect to the center of the circle of the gasket portion 110. Similarly to the circumferential linear portion 122 in Embodiment 1 described above, the radial width in the upstream side of the circumferential linear portion 722 is larger than the radial width in the downstream side thereof, and a radially outer surface 722A is constituted by a tapered surface that tapers toward the downstream side. The dimensions of each surface constituting the circumferential linear portion 722, the taper angle of the surface 722A, and the manner of deformation of the flow-regulating net portion 720 based on the airflow are the same as those in Embodiment 1. That is, the present modification is different from Embodiment 1 described above only in that the flow-regulating net portion 720 is provided over the entire area inside the gasket portion 110. However, although not shown in the drawings, with regard to the positional relationship between the intake noise reduction device 700 and the throttle valve 400 in the intake pipe, the interval between the throttle valve 400 and the flow-regulating net portion 720 is set to be longer than half of the length of the valve main body part of the throttle valve 400 such that the opened throttle valve 400 does not come into contact with the flow-regulating net portion 720.

Also in the thus configured intake noise reduction device 700 according to the present modification, effects similar to those of Embodiment 1 described above are able to be achieved. That is, even when the circumferential linear portion 722 rotates by the deformation of the flow-regulating net portion 720, the surface 722A does not cause the projected area of the circumferential linear portion 722 to increase, and hence it becomes possible to suppress the reduction in the airflow amount. According to the present modification, it becomes possible to regulate air flowing in the intake over a wide range.

FIG. 8 is a schematic cross-sectional view of an intake noise reduction device according to Modification 2 of the present disclosure, and is a cross-sectional view similar to FIG. 2 described above. An intake noise reduction device 800 according to the present modification is constituted, similarly to Embodiment 2 described above, by the annular gasket portion 110 and a flow-regulating net portion 820. Similarly to the case of Embodiment 2, the flow-regulating net portion 820 is constituted by a plurality of the radial linear portions 121 that radially extend outwardly from the center of the circle of the gasket portion 110 in the radial manner, and a plurality of circumferential linear portions 822 that circumferentially extend concentrically with respect to the center of the above-described circle of the gasket portion 110. Similarly to the circumferential linear portion 622 in Embodiment 2 described above, the radial width in the upstream side of the circumferential linear portion 822 is smaller than the radial width in the downstream side thereof, and a radially inner surface 822B is constituted by a reverse tapered surface that tapers toward the upstream side. The dimensions of each surface constituting the circumferential linear portion 822, the taper angle of the surface 822B, and the manner of deformation of the flow-regulating net portion 820 based on the airflow are the same as those in Embodiment 2. That is, the present modification is different from Embodiment 2 described above only in that the flow-regulating net portion 820 is provided over the entire area inside the gasket portion 110. Although not shown in the drawings, the positional relationship between the intake noise reduction device 800 and the throttle valve 400 in the intake pipe is similar to that in Modification 1 described above.

In the thus configured intake noise reduction device 800 according to the present modification, effects similar to those of Embodiment 2 described above are obtained. That is, when the circumferential linear portion 822 rotates by the deformation of the flow-regulating net portion 820, the projected area of the surface 822B decreases, and hence it becomes possible to suppress the reduction in the airflow amount. According to the present modification, it becomes possible to regulate air flowing in the intake over a wide range.

### Others

In the embodiments and the modifications described above, the angles between the adjacent radial linear portions are set to be substantially equal to each other, and the radial intervals between the adjacent circumferential linear portions are set to be substantially equal to each other. The taper angles of the tapered surfaces or the reverse tapered surfaces provided in a plurality of the circumferential linear portions have the same angle. However, these values may be appropriately changed as long as the function and effect of the present disclosure are achieved. For example, in the present disclosure, since the flow-regulating net portion can elastically deform, the taper angle of the tapered surface provided in each circumferential linear portion may be appropriately changed in consideration of the deformation state during the use. That is, in the state during intended use, the taper angle, etc., may be appropriately set such that each rotated tapered surface becomes parallel to the direction of the airflow.

### REFERENCE SIGNS LIST

100, 600, 700, 800 Intake noise reduction device
110 Gasket portion
120, 620, 720, 820 Flow-regulating net portion
121 Radial linear portion
122, 622, 722, 822 Circumferential linear portion
200 Intake manifold
300 Throttle body
400 Throttle valve

1. An intake noise reduction device made of an elastic body that is disposed downstream of a throttle valve in an intake pipe and reduces an intake noise, the intake noise reduction device comprising:
an annular gasket portion that seals a gap between an end surface of one of two pipes constituting the intake pipe and an end surface of the other pipe of the two pipes; and
a flow-regulating net portion that is provided inside the gasket portion integrally with the gasket portion, constituted by a linear portion having a mesh shape, and configured to reduce the intake noise by regulating an airflow, wherein
the linear portion having the mesh shape constituting the flow-regulating net portion includes a circumferential linear portion that extends circumferentially, and
a radial width of the circumferential linear portion is larger in the upstream side than in the downstream side with respect to the airflow direction and a radially outer surface of the circumferential linear portion has a tapered surface that tapers toward the downstream side with respect to the airflow direction.

2. The intake noise reduction device according to claim 1, wherein the tapered surface is configured to be substantially parallel to a direction of the airflow in a deformation state of the flow-regulating net portion where a flow amount of air passing through the flow-regulating net portion exceeds a predetermined amount.

3. The intake noise reduction device according to claim 2, wherein
the linear portion having the mesh shape further includes a radial linear portion that is provided integrally with the circumferential linear portion and extends radially,
the radial linear portion has an end surface in the upstream side that is perpendicular to the airflow in a state where the flow-regulating net portion does not deform, and
the flow-regulating net portion is configured to satisfy θ1≧θ2, where θ1 is an angle between (a) the end surface in the upstream side of the radial linear portion when the flow-regulating net portion is in the deformation state and (b) a plane perpendicular to the airflow, and θ2 is a taper angle of the tapered surface of the circumferential linear portion.

4. An intake noise reduction device made of an elastic body that is disposed downstream of a throttle valve in an intake pipe and reduces an intake noise, the intake noise reduction device comprising:
an annular gasket portion that seals a gap between an end surface of one of two pipes constituting the intake pipe and an end surface of the other pipe of the two pipes; and
a flow-regulating net portion that is provided inside the gasket portion integrally with the gasket portion, constituted by a linear portion having a mesh shape, and configured to reduce the intake noise by regulating an airflow, wherein
the linear portion having the mesh shape constituting the flow-regulating net portion includes a circumferential linear portion that extends circumferentially, and
a radial width of the circumferential linear portion is smaller in the upstream side than in the downstream side with respect to the airflow direction and a radially inner surface of the circumferential linear portion has a reverse tapered surface that tapers toward the upstream side with respect to the airflow direction.

5. The intake noise reduction device according to claim 4, wherein
the reverse tapered surface is configured to be substantially parallel to a direction of the airflow in a deformation state of the flow-regulating net portion where a flow amount of air passing through the flow-regulating net portion exceeds a predetermined amount.
